(19) United States
(12) Patent Application Publication
(10) Pub. No.: US 2014/0165860 A1
(43) Pub. Date: Jun. 19, 2014

(54) LEVEL COMPENSATION DEVICE

(71) Applicants: Hon Hai Precision Industry Co., Ltd., New Taipei (TW); Fu Tai Hua Industry (Shenzhen) Co., Ltd., Shenzhen (CN)

(72) Inventors: GANG-TAO FAN, Shenzhen (CN); MU-RUI PENG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/972,864

(22) Filed: Aug. 21, 2013

(30) Foreign Application Priority Data
Dec. 14, 2012 (CN) 2012105422250

(51) Int. Cl. B30B 7/00

(52) U.S. Cl. CPC B30B 7/00
USPC 100/258 R

(57) ABSTRACT

A level compensation device for compensating an angle formed between a lifting mechanism and a pressing device which is horizontally placed on a product is provided. The level compensation device includes a base to be horizontally placed on the pressing device, and a rotatable plate rotatably connected to the base. The rotatable plate is driven by an external force to rotate relative to the base until an angle formed between the rotatable plate and the base is equal to the angle formed between the lifting mechanism and the pressing device.

BACKGROUND

1. Technical Field

The present disclosure relates to compensation devices, and particularly to a level compensation device for compensating an angle of a lifting mechanism.

2. Description of Related Art

In order to press product, a lifting mechanism is used to horizontally press a pressing device which is horizontally placed on a product. However, the pressing device cannot horizontally press the product when there is angle formed by the lifting mechanism and the pressing device.

Therefore, what is needed is a level compensation device to overcome the described limitations.

### BRIEF DESCRIPTION OF THE DRAWINGS

FIG. 1 is a schematic view of a level compensation device for compensating an angle generated by a lifting mechanism.

FIG. 2 is an isometric view of a level compensation device in accordance with an exemplary embodiment.

FIG. 3 is an exploded view of the level compensation device of FIG. 2.

FIG. 4 is a cross-section view of the level compensation device of FIG. 2 along line IV-IV, in a first state.

FIG. 5 is a cross-section view of the level compensation device of FIG. 2 along line IV-IV, in a second state.

### DETAILED DESCRIPTION

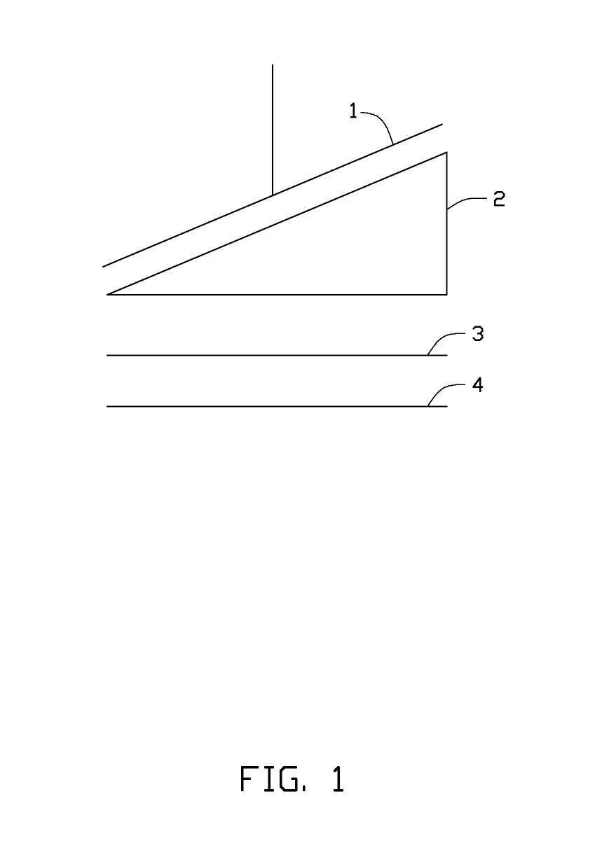

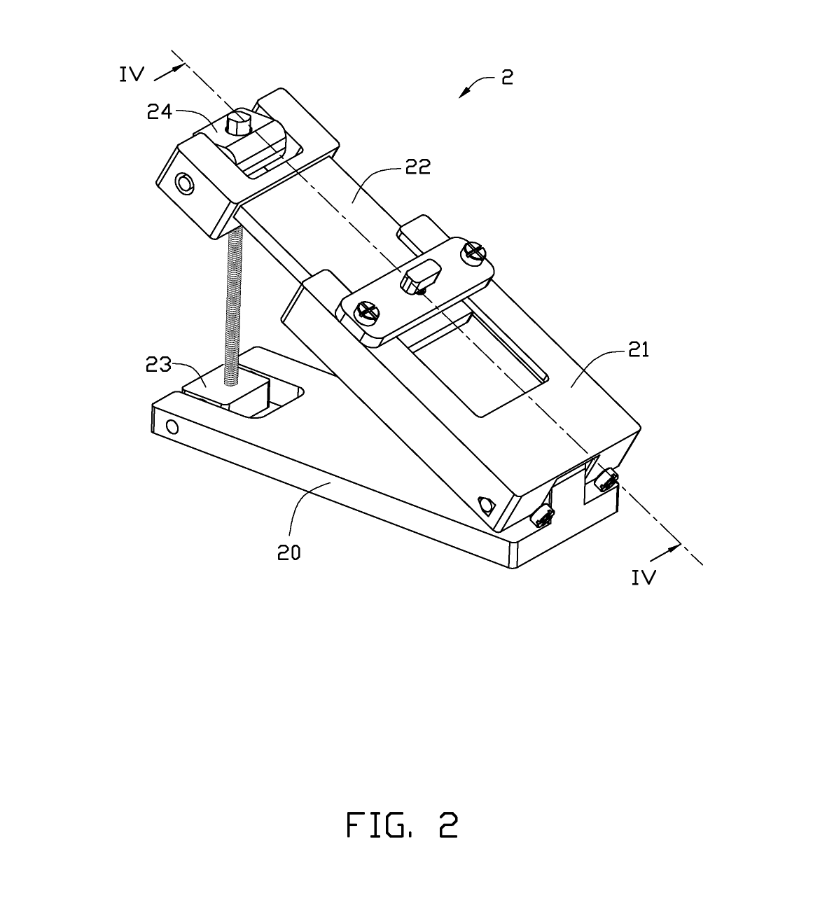

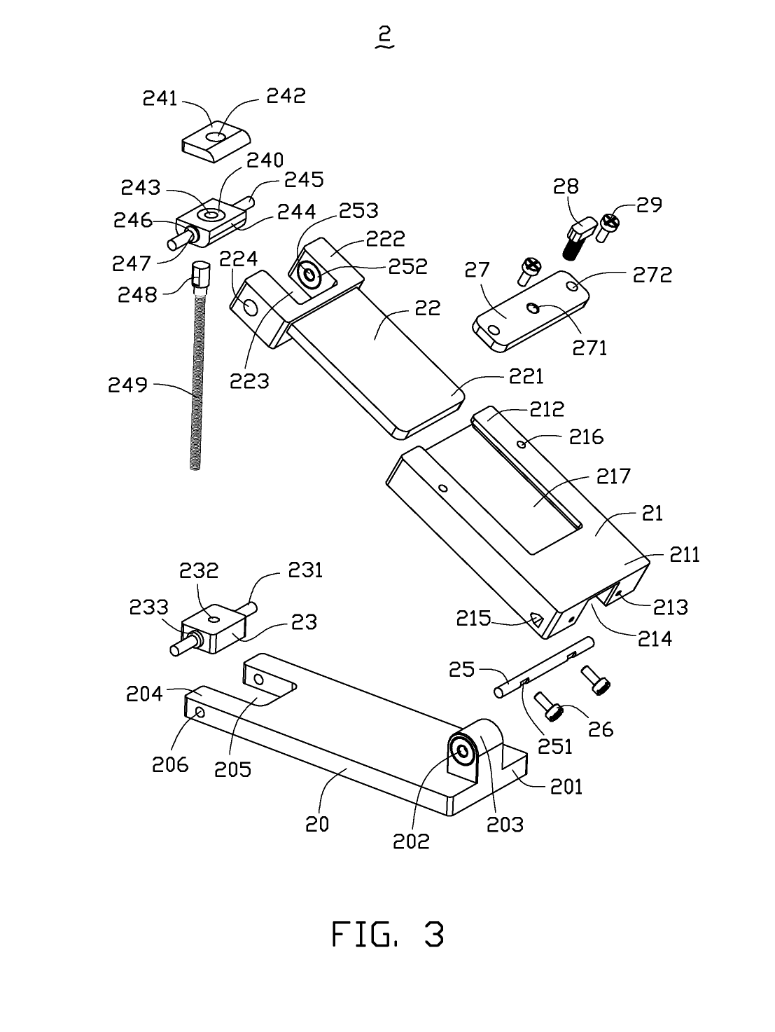

FIGS. 1-3 shows a level compensation device 2 for compensating an angle formed between a lifting mechanism 1 and a pressing device 3. A product 4 is placed below the pressing device 3. The level compensation device 2 includes a base 20 horizontally placed on the pressing device 3, a rotatable plate 21 rotatably connected to the base 20, an adjustable plate 22 movably connected to the rotatable plate 21, a fixing block 23 rotatably connected to the base 20, and a movable mechanism 24 movably connected between the fixing block 23 and the adjustable plate 22. When compensating the angle formed between the lifting mechanism 1 and the pressing device 3, the rotatable plate 21 is driven by an external force to rotate relative to the base 20 until the angle formed between the rotatable plate 21 and the base 20 is equal to the angle formed between the lifting mechanism 1 and the pressing device 3, the adjustable plate 22 is adjusted by the external force until the movable mechanism 24 is able to fasten between the fixing block 23 and the adjustable plate 22.

A protrusion 203 is protruded from a first end 201 of the base 20. In one embodiment, the shape of an upper surface of the protrusion 203 is elliptic. The protrusion 203 defines a first axel hole 202 along a horizontally direction. A first opening 205 is defined in a second end 204 of the base 20. The fixing block 23 is rotatably connected to two sides of the first opening 205. Two fourth axel holes 206 are defined in two sides of the second end 204 of the base 20.

The fixing block 23 defines a fifth axel hole 233 aligned with the two fourth axels 206 along a horizontal direction, and defines a first perforation 232 along a vertical direction.

The level compensation device 2 further includes a third shaft 231. The third shaft 231 passes through the two fourth axels 206 and the fifth axel hole 233 to rotatably connect the fixing block 23 to the second end 204 of the base 20.

A first end 211 of the rotatable plate 21 defines a recessed portion 214 for receiving the protrusion 203. Two sides of the first end 211 define two second axel holes 215 aligned with the first axel hole 202. In one embodiment, the shape of the second axel hole 215 is stepped. The first end 211 further defines two third axel holes 213. A second end 212 of the rotatable plate 21 defines a groove 217 and two second blind holes 216.

The level compensation device 2 further includes a first shaft 25 and two first screws 26. The first shaft 25 defines two first bind holes 251 aligned with the two third axel holes 213. The first shaft 25 passes through the two second axel holes 215 and the first axel hole 202 to rotatably connect the rotatable plate 21 to the base 20. The two first screws 26 pass through the two third axel holes 213 to abut the two bind holes 251 of the first shaft 25 to fix the first shaft 25 within the two second axel holes 215, thereby keeping an angle formed by the rotatable plate 21 and the base 20. The diameter of the two second axel holes 215 gradually decreases along a direction from the first end 211 to the second end 212, due to the limitation of the diameter of second axel holes 215, the shaft 25 cannot be rotated within the two second axel holes 215 when the first shaft 25 is abut by the two first screws to move a predetermined distance along the two second axel holes 215.

A first end 221 of the adjustable plate 22 is movably placed in the groove 217. A second end 222 of the adjustable plate 22 defines a second opening 223 at a centre thereof. Two sides of the second end 222 of the adjustable plate 22 define two sixth axel holes 224.

The level compensation device 2 further includes a locking block 27 placed on the adjustable plate 22, a locking shaft 28 placed on the locking block 27 and two second screws 29. The locking block 27 defines two first threaded holes 272 aligned with the two second blind holes 216, and a second threaded hole 271. The two second screws 29 pass through the two first threaded holes 216 to fix the locking block 27 to the rotatable plate 21. The locking shaft 29 passes through the second threaded hole 271 to fix the rotatable plate 21 to the groove 217.

The movable mechanism 24 is movably placed in the second opening 223. The movable mechanism 24 includes an upper portion 241, a lower portion 244 fixed to the upper portion 241, a first bearing 240 placed on the lower portion 244, a bolt 249, and two second bearings 252. The upper portion 241 defines a second perforation 242. The lower portion 244 defines a seventh axel hole 246 aligned with the two sixth axel holes 224, and an eighth axel hole 243 communicating with the seventh axel hole 246 in a top portion. The bolt 249 defines a second through hole 248. The second bearing 252 defines a bearing hole 253. Each of the two second bearings 252 is placed between the lower portion 244 and the side of the second opening 223.

The level compensation device 2 includes a fourth shaft 245 defining a first through hole 247 in a centre. The bolt 249 passes through the second perforation 242, the eighth axel hole 243, the first bearing 240, the first perforation 232 to fix the movable mechanism 24 between the adjustable plate 22 and the fixing block 23. The fourth shaft 245 passes through the two sixth axel holes 224, the bearing hole 253 and the seventh axel hole 246 to rotatably connect the lower portion 244 to the second end 222 of the adjustable plate 22.

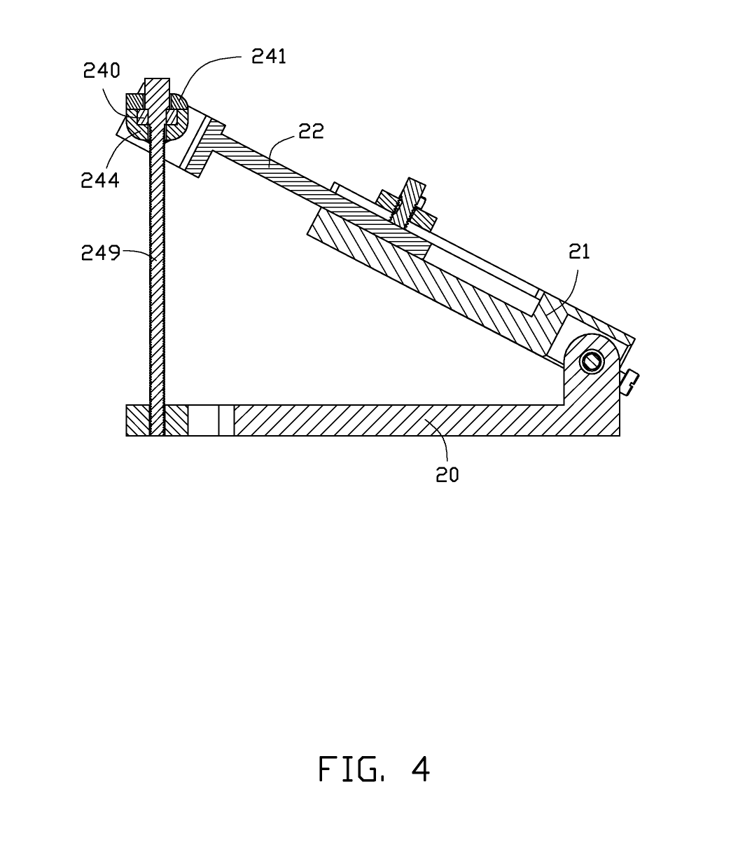

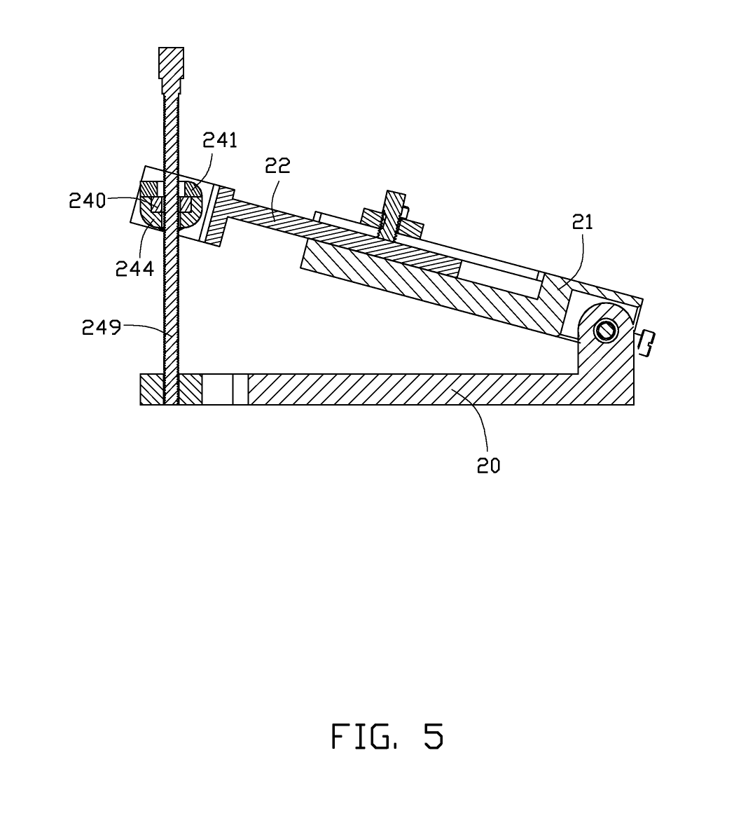

FIGS. 4-5 show that in order to compensate the angle formed between the lifting mechanism 1 and the pressing device 3, the bolt 249 is rotated out of the lower portion 244 and the fixing block 23. The two first screws 26 are moved from the two first blind holes 251 and the two third axel holes 213 to release a limitation of the first shaft 25. The rotatable plate 21 is rotated relative to the base 20 until an angle formed between the rotatable plate 21 and the base 20 is equal to the angle formed between the lifting mechanism 1 and the pressing device 3. The two first screws 26 are inserted into the two first blind holes 251 and the two third axel holes 213 to abut the first shaft 25 in the second axel hole 215 until the first shaft 25 is fixed in the second axel hole 215, thereby keeping the angle formed between the rotatable plate 21 and the base 2. Thus, the adjustable plate 22 is adjusted relative to the rotatable plate 21; the lower portion 244 is adjusted until the bolt 249 can be fixed between the lower portion 244 and the fixing block 23, thereby making the level compensation device 2 to steadily support the lifting mechanism 1, and compensating the angle formed between the lifting mechanism 1 and the pressing device 3.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A level compensation device for compensating an angle formed between a lifting mechanism and a pressing device which is horizontally placed on a product, the level compensation device comprising:
a base for being horizontally placed on the pressing device; and
a rotatable plate rotatably connected to the base;
wherein the rotatable plate is driven by an external force to rotate relative to the base until an angle formed between the rotatable plate and the base is equal to the angle formed between the lifting mechanism and the pressing device.

2. The level compensation device as described in claim 1, further comprising:
an adjustable plate movably connected to the rotatable plate;
a fixing block rotatably connected to the base; and
a movable mechanism movably connected between the fixing block and the adjustable plate.

3. The level compensation device as described in claim 1, wherein a protrusion is protruded from a first end of the base, the protrusion defines a first axel hole along a horizontal direction, a first end of the rotatable plate defines a recessed portion for receiving the protrusion, two sides of the first end of the rotatable plate defines two second axel holes aligned with the first axel hole, the first end of the rotatable plate further defines two third axel holes along a lengthwise direction of the rotatable plate, the level compensation device further comprises a first shaft and two first screws, the first shaft defines two first blind holes aligned with two third axel holes, the first shaft passes through the two second axel holes and the first axel hole to rotatably connect the rotatable plate to the base, and the two first screws pass through the third axel holes to abut the two first blind holes of the first shaft in the two second axel holes to keep the angle formed between the rotatable plate and the base.

4. The level compensation device as described in claim 2, wherein a shape of the two second axel holes is stepped.

5. The level compensation device as described in claim 2, wherein a second end of the rotatable plate defines a groove on a top surface thereof, and two second blind holes, a first end of the adjustable plate is movably placed in the groove, the level compensation device further comprises a locking block placed on the adjustable plate, a locking shaft placed on the locking block and two second screws, the locking block defines two first threaded holes aligned with the two second blind holes, and a second threaded hole, the two second screws pass through the two first threaded holes and the two second blind holes to fix the locking block to the rotatable plate, and the locking shaft passes through the second threaded hole to fix the adjustable plate to the groove of the rotatable plate.

6. The level compensation device as described in claim 2, wherein a second end of the base defines a first opening at a centre thereof, and two fourth axel holes at two sides thereof, the fixing block defines a fifth axel holes aligned with the two fourth axel holes along a horizontal direction, the level compensation device further comprises a third shaft, and the third shaft passes through the two fourth axel holes and the fifth axel hole to rotatably connect the fixing block to the second end of the base.

7. The level compensation device as described in claim 5, wherein the fixing block defines a first perforation along a vertical direction, a second end of the adjustable plate defines a second opening at a centre thereof, and two sixth axel holes along a horizontal direction, the movable mechanism is placed in the second opening, the movable mechanism comprises a upper portion, a lower portion fixed to the upper portion, a first bearing placed on the lower portion, a bolt, and two second bearings, the upper portion defines a second perforation, the lower portion defines a seventh axel hole aligned with the two sixth axel holes, and a eighth axel hole communicating with the seventh axel hole, each of the two second bearings defines a bearing hole, and is placed between the lower portion and the side of the second opening, the level compensation device further comprises a fourth shaft, the fourth shaft defines a first through hole at a centre thereof, the bolt defines a second through hole, the bolt passes through the second perforation, the eighth axel hole, the first bearing and the first perforation to fix the movable mechanism between the adjustable plate and the fixing block, and the fourth shaft passes through the sixth axel hole, the two bearing holes, and the seventh axel hole to rotatably connect the lower portion to the second end of the adjustable plate.
